(19) United States
(12) Patent Application Publication
(10) Pub. No.: US 2025/0045780 A1
(43) Pub. Date: Feb. 6, 2025

(54) SYSTEM AND METHOD FOR DEVELOPING UNIFIED DIGITAL PLATFORM BASED VIRTUAL POWER BANKS

(71) Applicant: Cognizant Technology Solutions India Pvt. Ltd., Chennai (IN)

(72) Inventors: Prakhar CHAUDHARY, Ghaziabad (IN); Robert RAJASEKAR FRANKLIN MERLIN, Kanyakumarai (IN); Romeel SEDANI, Amravati (IN); Susmita BARUAH, Guwahati (IN); Babu CHINNIAH LAKSHMANAN, Chennai (IN); Srinivasan RENGACHARI, Chennai (IN)

(73) Assignee: Cognizant Technology Solutions India Pvt. Ltd., Chennai (IN)

(21) Appl. No.: 18/371,096

(22) Filed: Sep. 21, 2023

(30) Foreign Application Priority Data
Aug. 4, 2023 (IN) 202341052528

(51) Int. Cl. G06Q 30/0201; G06Q 20/02; G06Q 50/06

(52) U.S. Cl. CPC G06Q 30/0201; G06Q 20/02; G06Q 50/06; G06Q 2220/00

(57) ABSTRACT

A system and method for developing unified digital platform based virtual power banks is provided. A second data type is derived by analyzing record types. The record types are obtained from the first data type received from multiple sources. Virtual power banks are generated by employing the first and second data types fetched from database. Dynamic actionable items relating to the virtual power banks are generated from the first data type and the second data type. One or more variables are identified that correspond to different types of dynamic actionable items for categorizing the dynamic actionable items based on the identified variables. Lastly, optimization operations are performed on values of each of the identified variables to obtain an optimized final weightage value of the virtual power banks, accessed via a unified digital platform, based on which one or more operational parameters associated with the virtual power banks are determined.

### CROSS-REFERENCE TO RELATED APPLICATION

This application claims priority to Indian Patent Application No. 202341052528, filed Aug. 4, 2023, which is hereby incorporated by reference in its entirety.

### FIELD

The present invention relates generally to the field of digital platforms of utility industries. More particularly, the present invention relates to a system and a method for developing unified digital platform based virtual power banks for power management and settlement.

### BACKGROUND

Clean energy being the need of the current times, utility industries (utilities) are developing new products and technology for achieving Environment, Social and Governance (ESG) objectives. One of the ESG objectives is meeting carbon emission targets based on decarbonization operations. In order to meet carbon emission targets, the contribution of utility industries is essential for reducing the carbon footprint linked to carbon emissions. One of the measures used for reducing carbon footprint is energy transition entailing electricity generation from one or more renewable energy sources (e.g., solar energy, wind energy, biogas, geothermal energy, hydro energy, etc.).

It has been observed that no proper mechanism or interface exists that allows end-consumers to access the renewable energy sources for consumption. Further, existing digital platforms do not have mechanisms in place to track sources of energy (e.g., as renewable, or conventional). Also, it has been observed that energy consumption patterns associated with renewable energy sources (e.g., batteries used in an Electric Vehicles (EV)) are unpredictable, which may lead to one or more issues such as, but are not limited to, inaccurate load management, grid failures, power loss, voltage instability, inadequate power pricing mechanism, and harmonic distortion. Further, existing digital platforms do not provide functionalities to visualize power sources which may be suitably utilized and re-utilized.

In light of the aforementioned drawbacks, there is a need for a digital platform for access to power generated from renewable energy sources and efficient power management and settlement. There is a need for a system and a method for developing unified digital platform based virtual power banks for power management and settlement. Also, there is a need for a system and a method which provides for enhanced transparency in utilization of renewable energy sources by end-consumers for accelerating renewable energy usage. Further, there is a need for a system and a method which provides for tracking sources of power generation. Furthermore, there is a need for a system and a method which provides for locating and buying unused and used power generated from renewable energy sources. Yet further, there is a need for a system and a method which provides for assessing one or more variables associated with real-time power supply and demand.

### SUMMARY

In various embodiments of the invention, a system for developing unified digital platform based virtual power banks is provided. The system comprises a memory storing program instructions, a processor executing program instructions stored in the memory. The system is configured to derive a second data type by analyzing one or more record types. The record types are obtained from a first data type received from multiple sources and stored in a database. The system is configured to generate virtual power banks by employing the first data type and the second data type fetched from the database. The virtual power banks are associated with one or more attributes relating to power management and settlement. Further, the system is configured to generate one or more dynamic actionable items relating to the virtual power banks from the first data type and the second data type. Further, the system is configured to identify one or more variables that correspond to different types of the dynamic actionable items for categorizing the dynamic actionable items based on the identified variables. Lastly, the system is configured to perform optimization operations on values of each of the identified variables to obtain an optimized final weightage value of the virtual power banks, accessed via a unified digital platform, based on which one or more operational parameters associated with the virtual power banks are determined.

In various embodiments of the invention, a method for developing unified digital platform based virtual power banks is provided. The method is implemented by a processor configured to execute instructions stored in a memory. The method comprises deriving a second data type by analyzing one or more record types. The record types are obtained from a first data type received from multiple sources and stored in a database. The method comprises generating virtual power banks by employing the first data type and the second data type fetched from the database. The virtual power banks are associated with one or more attributes relating to power bank management and settlement. The method comprises generating one or more dynamic actionable items relating to the virtual power banks from the first data type and the second data type. Further, the method comprises identifying one or more variables that correspond to different types of the dynamic actionable items for categorizing the dynamic actionable items based on the identified variables. Lastly, the method comprises performing optimization operations on values of each of the identified variables associated with the dynamic actionable items to obtain an optimized final weightage value of the virtual power banks, accessed via the unified digital platform (106a), based on which one or more operational parameters associated with the virtual power banks are determined.

In various embodiments of the invention, a computer program product is provided. The computer program product comprises a non-transitory computer-readable medium having computer program code stored thereon, the computer-readable program code comprising instructions that, when executed by a processor, causes the processor to derive a second data type by analyzing one or more record types. The record types are obtained from a first data type received from multiple sources and stored in a database. Further, virtual power banks are generated by employing the first data type and the second data type fetched from the database. The virtual power banks are associated with one or more attributes relating to power management and settlement. Further, one or more dynamic actionable items relating to the virtual power banks are generated from the first data type and the second data type. Further, one or more variables that correspond to different types of the dynamic actionable items are identified for categorizing the dynamic actionable items based on the identified variables. Lastly, optimization operations are performed on values of each of the identified variables to obtain an optimized final weightage value of the virtual power banks, accessed via a unified digital platform, based on which one or more operational parameters associated with the virtual power banks are determined.

### BRIEF DESCRIPTION OF THE ACCOMPANYING DRAWINGS

The present invention is described by way of embodiments illustrated in the accompanying drawings wherein:

FIG. 1 is a detailed block diagram of a system for developing unified digital platform based virtual power banks for power management and settlement, in accordance with an embodiment of the present invention;

FIG. 2 illustrates an exemplary flow diagram for providing virtual power banks hosted on a unified cloud-based platform, in accordance with an embodiment of the present invention;

FIG. 3 and FIG. 3A is a flowchart illustrating a method for developing unified digital platform based virtual power banks for power management and settlement, in accordance with an embodiment of the present invention; and

FIG. 4 illustrates an exemplary computer system in which various embodiments of the present invention may be implemented.

### DETAILED DESCRIPTION

The present invention discloses a system and a method for developing unified digital platform based virtual power banks for power management and settlement. The present invention discloses a system and a method for efficient utilization and re-utilization of power generated from renewable energy sources. The present invention discloses a system and a method which provides for enhanced transparency in the utilization of power generated from renewable energy sources by end-consumers for accelerating renewable energy usage. Also, the present invention discloses a system and a method which provides for tracking the source of power. Further, the present invention discloses a system and a method which provides for locating unused and used power generated from renewable energy sources. Furthermore, the present invention discloses a system and a method which provides for segregating the power generated from the renewable energy sources into small quantum based on demand on the digital platform. Yet further, the present invention discloses a system and a method which provides for improved load forecasting demand associated with the renewable energy source power to prevent grid failure, power loss, voltage instability and harmonic distortion based on automatically determining needs and requirements associated with the consumer's demand.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

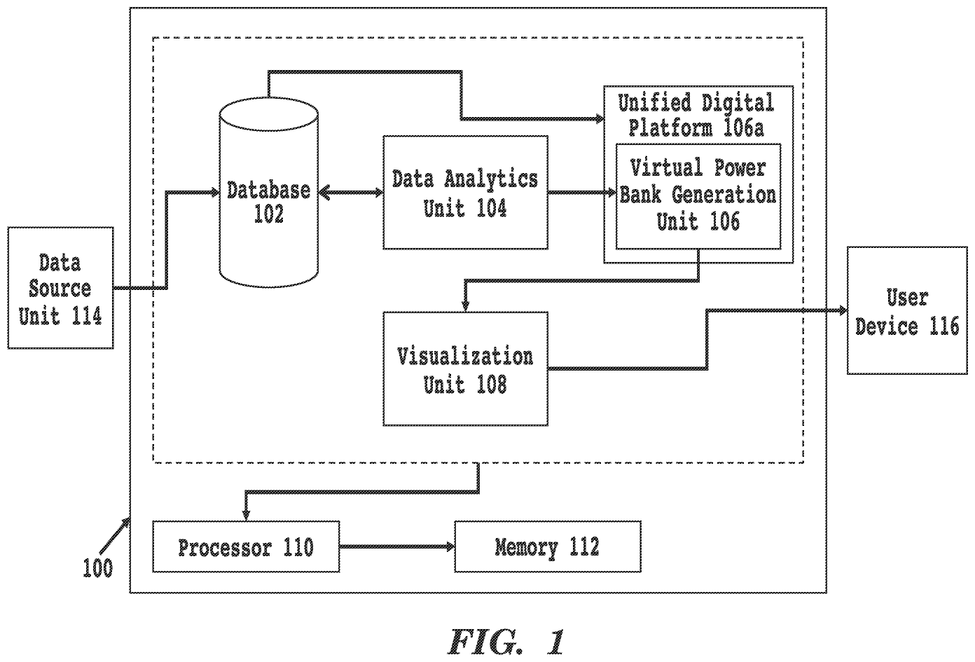

FIG. 1 is a detailed block diagram of a system 100 for developing unified digital platform based virtual power banks for power management and settlement, in accordance with various embodiments of the present invention. Referring to FIG. 1, in an embodiment of the present invention, the system 100 is in communication with a data source unit 114 and a user device 116 via a communication channel (not shown). In an exemplary embodiment of the present invention, the user device 116 includes electronic devices such as a smartphone, a computer and a laptop. The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a Local Area Network (LAN), a Metropolitan Area Network (MAN) and a Wide Area Network (WAN).

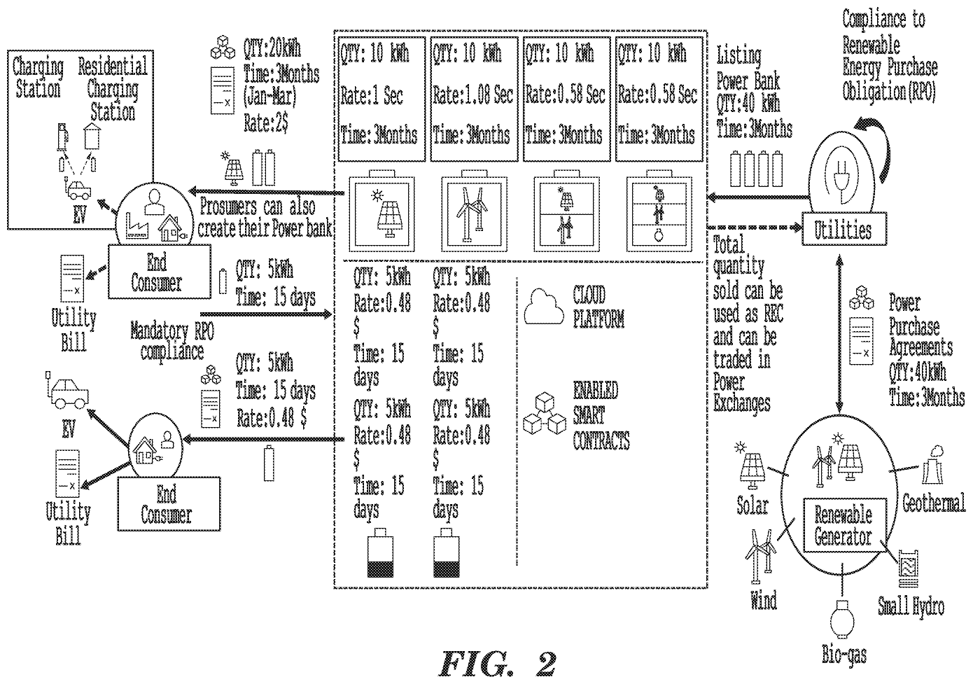

In an embodiment of the present invention, the system 100 is configured with a built-in mechanism for generating unified digital platform based virtual power banks. The system 100 is configured to generate the virtual power banks on a unified cloud-based platform, as illustrated in FIG. 2, in accordance with an embodiment of the present invention. In an exemplary embodiment of the present invention, the unified cloud-based platform may include, but is not limited to, Azure®, Amazon Web Services® (AWS), etc., hosted on a private cloud. The system 100 is configured to provide a bi-directional communication between an end-consumer and a utility retailer through a unified digital platform 106a. The system 100 provides for power/energy management and settlement (e.g., purchase and sale of renewable energy) in the form of the virtual power banks through the unified digital platform 106a. For example, the purchased virtual power bank may be used by end-consumers for charging Electric Vehicles (EVs) with clean energy generated from renewable sources and also set off units in monthly utility bills, within permissible time limit. The remaining unutilized energy of the virtual power banks may also be resold to other consumers through the unified digital platform 106a by the end-consumers by creating their own power banks. Through this unified digital platform 106a, any consumer who self-generates electricity (e.g., through roof top solar panels) can also feed their self-generated renewable energy to power grids or the remaining power stored in their EV batteries to feed EV batteries of other consumers.

In an embodiment of the present invention, the system comprises a database 102, a data analytics unit 104, a virtual power bank generation unit 106 and a visualization unit 108. In an embodiment of the present invention, the system 100 comprises a processor 110 and a memory 112. In various embodiments of the present invention, the system 100 has multiple units which work in conjunction with each other for generating a smart contract associated with power generated from renewable energy sources. The various units of the system 100 are operated via the processor 110 specifically programmed to execute instructions stored in the memory 112 for executing respective functionalities of the units of the system 100 in accordance with various embodiments of the present invention.

In an embodiment of the present invention, the system 100 is implemented in a cloud computing architecture in which data, applications, services, and other sources are stored and delivered through shared datacenters. In an exemplary embodiment of the present invention, the functionalities of the system 100 are delivered to a user as a Platform as a Service (PaaS) over a communication network.

In operation, in an embodiment of the present invention, the database 102 is configured to receive a first data type from multiple sources. The first data type represents data relating to power usage and requirements associated with multiple sources. The multiple sources include, but are not limited to, renewable energy generators, utility retailers, end-consumers, and Electric Vehicles (EV) charging stations. The first data type is stored in the database 102 in the form of different record types associated with each of the multiple sources. The one or more record types may include, but are not limited to, Power Purchase Agreement (PPA) records associated with the renewable energy generators, Renewable Purchase Obligation (RPO) records associated with the utility retailers, Power Bank (PB) contract records associated with end-consumers, billing and payment records associated with the EV charging stations. The first data type also includes data related to real-time power supply and demand received from one or more utilities and data related to multiple variables which are stored in the database 102 (explained in detailed in later sections of the specification). In an embodiment of the present invention, the data analytics unit 104 fetches the record types from the database 102 for analysis and processing. In an embodiment of the present invention, the data analytics unit 104 is configured with one or more functionalities based on which the record types are analyzed and processed to derive a second data type. The one or more functionalities include, but are not limited to, enterprise resource planning, Power Purchase Agreement (PPA) and Renewable Purchase Obligation (RPO) record management, Power Bank (PB) contract management, contract and transaction management, and end-consumer data management. The data analytics unit 104 generates the second data type after analysis and processing of the record types and stores the second data type in the database 102. In an exemplary embodiment of the present invention, the second data type includes data related to power usage. In an example, the second data type includes a quantum of power to be supplied i.e., capacity of the power banks, for instance power banks may be of a smaller capacity of 100 units or higher capacity of 1000 units. In another example, the second data type includes duration of supply per terms of usage of the power banks, for instance, some power banks may hold a shorter duration of 3 months or 6 months, while some other power banks may have a higher duration of 1 year, 2 years, etc. In yet another example, the second data type includes negotiated price of the power bank, for instance, higher the purchasing quantity of power banks by the end-consumer lesser could be the price, and in another instance, higher the duration lesser could be the price. In another example, the second data type includes penalties for non-compliance related to power supply and usage per the RPO. In yet another example, the second data type includes data related to end-consumer segments, for instance, category of consumers such as residential consumers buying for self-usage and commercial consumers buying for re-selling. In another example, the second data type includes sources of power generation, for instance, solar generators are available in markets at lower feed in tariff rates.

In an embodiment of the present invention, the virtual power bank generation unit 106 generates virtual power banks by employing the first data type and the second data type fetched from the database 102. The virtual power banks are small quantum of power entities hosted in the cloud-based unified digital platform 106a. The virtual power banks are associated with one or more attributes including, but not limited to, different quantities of power (in kWh), time range for power utilization and price associated with the power based on the sources of renewable energy received from the renewable energy generators.

In an embodiment of the present invention, the virtual power banks utilize end-to-end encryption with blockchain technology containing smart contracts for its use by end-consumers, utility retailers and renewable energy generators. The smart contracts are digital logic agreements in a blockchain that contain terms which are automatically executed when pre-defined conditions related to power management and settlement through the virtual power banks are met. The smart contracts are generated based on the PPA record type of the second data type for the virtual power banks. In an exemplary embodiment of the present invention, the virtual power banks are operated based on four types of smart contracts. A first type of smart contract relates to PPA between the renewable energy generator and a utility retailer for trading renewable energy capacity. In an embodiment of the present invention, the first type of smart contract has a unique hash key function, which is generated between utility retailors and renewable energy generators and provides one or more predetermined conditions including, but are not limited to, quantity, price, and timeline of generated power. The first type of smart contract (referred to as a parent smart contract) is bifurcated into multiple sub-contracts (which are associated with virtual power banks) and are hosted in the cloud platform. Further, all the sub-contracts have a respective hash function, which is unique and random, thereby ensuring end-to-end encryption of the first type of smart contract. The hash function may be backtracked for generating the first type of contract. Further, the sub-contracts are purchased and sold multiple times and each sub-contract has a transaction appending buyer/seller token ID. A second type of smart contract relates to a PPA between the utility retailer and the end-consumer for trading the power bank. A third type of smart contract relates to a PPA between the end-consumer and EV retailer for transfer of energy for charging of the EV vehicles. A fourth type of smart contract relates to a peer-to-peer contract between consumers with other end-consumers or with retailers in selling their unused power banks or the self-generated renewable energy power or power stored in the EV batteries.

In an embodiment of the present invention, the virtual power bank generation unit 106 generates dynamic actionable items which relate to one or more operational parameters of the virtual power banks. The dynamic actionable items are generated from the first data type that includes data related to real-time power supply and demand received from one or more utilities and data related to multiple variables, and the second data type fetched from the database 102. The data related to real-time power demand includes demand from both ends i.e., availability of power banks from utilities and availability of end-consumers to purchase the power banks. The multiple variables are dynamic in nature and are identified based on empirical studies.

In one example, the variables include season or weather i.e., availability of solar radiation is usually less in winter and high in summers. In another example, the variables include landscape conditions for instance, renewable energy sources and their availability has a high impact on landscape types, i.e., solar intensity is high in low-lying areas like urban, semi-urban, rural, semi-rural and remote areas, etc. In yet another example, the variables include current market price i.e., the current renewable energy unit price in the market. In another example, the variables include frequent purchaser data. In yet another example, the variables include forecasted market price i.e., forecasted energy unit price of the market.

In an exemplary embodiment of the present invention, the dynamic actionable items include, but are not limited to, a segmented actionable item, a time-based actionable item, a peak actionable item, a penetration actionable item, a competitive actionable item, and a bulk actionable item. The segmented actionable item relates to an operational parameter of the virtual power bank based on geographical locations, frequency of usage, and duration of usage. The time-based actionable item relates to an operational parameter based on weather, and source of power generation. The peak actionable item relates to an operational parameter according to high demand times, and leverage data associated with the other power providers or generators, such as inventory or availability. The penetration actionable item relates to an operational parameter based on settling a lower value of power usage for effective management. The competitive actionable item relates to an operational parameter based on setting of a value of the power usage according to other power generators. The bulk actionable item relates to an operational parameter based on providing of a lower value to end-consumers for bulk usage.

In an embodiment of the present invention, the virtual power bank generation unit 106 generates the dynamic actionable items by employing the first data type and the second data type based on a sequence of steps. Firstly, the virtual power bank generation unit 106 determines a base value, which is a power procurement value between the end-consumer and the renewable energy generator based on the PPA between the utility and the renewable energy generator. Secondly, the virtual power bank generation unit 106 determines a utility value associated with infrastructure usage allowance based on which a threshold value is determined. The threshold value represents a minimum value below which the virtual power bank cannot be operated. Finally, the virtual power bank generation unit 106 determines an optimized weightage value of the virtual power banks based on the first data type and the second data type.

In an embodiment of the present invention, the virtual power bank generation unit 106 determines the optimized weightage value of the virtual power banks by initially identifying and processing the one or more multiple variables and determining one or more sub-variables associated with each of the multiple variables. For example, if the variable is weather and power is generated from solar energy, then the sub-variables may include, but are not limited to, sunny weather, cloudy weather, windy weather, rainy weather, snowy weather, and foggy weather, which may affect the power generation from the solar energy. In an embodiment of the present invention, the virtual power bank generation unit 106 computes an initial weightage value for each of the sub-variables. The virtual power bank generation unit 106 carries out a first optimization operation for optimizing the computed initial weightage values for each of the sub-variables. In an exemplary embodiment of the present invention, the first optimization operation is carried out by employing machine learning and deep learning techniques. During the first optimization operation, a model is trained iteratively that results in a maximum and minimum function evaluation. The results in every iteration are compared with each other by changing hyperparameters in each step until optimum results are obtained. Subsequently, an accurate model with less error rate is generated. In an exemplary embodiment of the present invention, the generated model is optimized by using two optimization techniques including, but are not limited to, a gradient descent optimization technique and a stochastic gradient descent optimization technique. Based on the gradient descent optimization technique, variables' weights are updated iteratively in the opposite direction of one or more gradients of an objective function, which causes the model to find a target and converge an optimal value of the objective function based on each update of the weights. The convergence to the optimal value of the optimal function provides the optimal weights for the features. Based on the stochastic gradient descent technique, gradients per iteration are updated using one sample randomly instead of directly computing exact value of the gradient. Therefore, stochastic gradient descent technique provides an unbiased estimate of the real gradient. Advantageously, the stochastic gradient descent technique optimization method reduces the update time for processing a large number of samples and removes computational redundancy. Further, a proper learning rate of the model is determined for the stochastic gradient descent technique. The learning rate provides flexibility to the model by discarding certain segments of the data, however, the model may discard certain segments of data when the learning rate is high. Therefore, a low learning rate is carried out. The learning rate may be of different types including, but is not limited to, an adaptive gradient technique (Adagrad) that provides weights with a high gradient having low learning rate and vice versa, a Root Mean Squared Propagation (RMSprop) technique that adjusts the Adagrad method such that it reduces its monotonically decreasing learning rate, an Adam technique, which is similar to RMSProp but provides momentum, and an Alternating Direction Method of Multipliers (ADMM) technique that provides the stochastic gradient descent variants which is widely used in deep neural network techniques. Further, the gradient descent and AdaGrad technique varies with respect to each other based on the learning rate, which is not fixed, and the learning rate is computed using all the historical gradients accumulated up to the latest iteration. The optimized initial weightage values computed for each of the sub-variables have been illustrated in table 1.

TABLE 1

| V. No. | Variables | Sub Variables | | | | | |
|---|---|---|---|---|---|---|---|
| V1 | Weather | Sunny-10 | Cloudy-5 | Windy-6 | Rainy-3 | Snowy-8 | Foggy-5 |
| V2 | Landscape | Urban- 10 | Semi-Urban-8 | Rural- 5 | Semi-rural-6 | Remote- | |
| | | | | | | 4 | |
| V3 | Demand or | High demand- | Low demand- | High demand- | Low demand- | — | — |
| | Load | PB- 10 | PB-4 | Consumer-10 | Consumer- 4 | | |
| V4 | Source of | Solar-6 | Wind-7 | Biogas-10 | Small Hydro-9 | — | — |
| | Generation | | | | | | |
| V5 | Duration or | Short | Medium Term-8 | Long Term-7 | Ultra-Long | — | — |
| | Term of PB | Term-10 | | | Term-6 | | |
| V6 | Quantity of | Low Capacity- | Medium | High Capacity-7 | Ultra-High | — | — |
| | PB | 10 | Capacity-8 | | Capacity-6 | | |
| V7 | Consumer | Residential-6 | Commercial-7 | Industrial-8 | Ancillary | — | — |
| | Segments | | | | Services-8 | | |
| V8 | Current | High-10 | In Sync-5 | Low-2 | — | — | — |
| | Market Price | | | | | | |
| V9 | RPO | High Penality- | Medium | Low Penality-3 | — | — | — |
| | Compliance | 10 | Penality-5 | | | | |
| | Penalties | | | | | | |
| V10 | Frequent | Very Frequent- | Medium | Occasionally-6 | First Time- | — | — |
| | Purchaser | 10 | Frequent-8 | | 4 | | |
| V11 | Forecasted | High-10 | In Sync-5 | Low-2 | — | — | — |
| | Market Price | | | | | | |

In an embodiment of the present invention, the virtual power bank generation unit 106 captures data associated with the sub-variables for an end-consumer who accesses the unified digital platform 106a for obtaining the virtual power bank. Based on the captured data, the virtual power bank generation unit 106 analyzes interdependency between each sub-variable with respect to another sub-variable in a matrix form across rows and columns of the matrix, as illustrated in table 2. Based on the interdependency analysis, the virtual power bank generation unit 106 adds the initial weightage values of the interdepending sub-variables and subsequently assigns a label (e.g., high, closer to high, medium, greater than medium, less than medium, low, etc.) to each of the sub-variables. The virtual power bank generation unit 106 then replaces the labels associated with each sub-variable with a numerical value. The virtual power bank generation unit 106 then carries out a second optimization operation for optimizing the initial weightage values by computing an average of the numerical values assigned to each of the sub-variable in either of each row or column of the matrix to generate a first weightage value for each of the variables, as illustrated in Table 3.

TABLE 2

| | | | | Demand/ | | | |
|---|---|---|---|---|---|---|---|
| | | | | Load | | Duration/ | Quantity |
| | | | | High- | Source of | Term of PB | of PB |
| | | Weather | Landscape | demand- | Generation | Medium | High |
| Variables | | Sunny | Semi-Urban | PB | Solar | Term | Capacity |
| Weather | Sunny | 0 | Closer to | High | >medium | Closer to | Closer to |
| | | | high | | | high | high |
| Landscape | Semi- | Closer to | 0 | Closer | >medium | >medium | >medium |
| | Urban | high | | to high | | | |
| Demand/ | High- | High | Closer to | 0 | Closer to | Closer to | Closer to |
| Load | demand- | | high | | high | high | high |
| | PB | | | | | | |
| Source of | Solar | >medium | >medium | Closer | 0 | >medium | >medium |
| Generation | | | | to high | | | |
| Duration/ | Medium | Closer to | Closer to | Closer | >medium | 0 | >medium |
| Term of PB | Term | high | high | to high | | | |
| Quantity of | High | Closer to | >medium | Closer | >medium | >medium | 0 |
| PB | Capacity | high | | to high | | | |
| Customer | Residential | Closer to | >medium | Closer | >medium | >medium | >medium |
| Segments | | high | | to high | | | |
| Current | In | >medium | >medium | >medium | >medium | >medium | >medium |
| Market price | Sync | | | | | | |
| RPO | High | >medium | Closer to | High | Closer to | Closer to | >medium |
| Compliance | Penalty | | high | | high | high | |
| Penalties | | | | | | | |
| Frequent | First | >medium | >medium | >medium | >medium | >medium | >medium |
| Purchaser | Time | | | | | | |
| Forecasted | Low | >medium | medium | >medium | medium | medium | <medium |
| Market Price | | | | | | | |

| | | | | RPO | | |
|---|---|---|---|---|---|---|
| | | | Current | Compliance | | |
| | | Customer | Market | Penalties | Frequent | Forecasted |
| | | Segments | Price | High | Purchaser | Market Price |
| Variables | | Residential | In Sync | Penalty | First Time | Low |
| Weather | Sunny | Closer to | >medium | >medium | >medium | >medium |
| | | high | | | | |
| Landscape | Semi- | >medium | >medium | Closer to | >medium | medium |
| | Urban | | | high | | |
| Demand/ | High- | Closer to | >medium | High | >medium | >medium |
| Load | demand- | high | | | | |
| | PB | | | | | |
| Source of | Solar | >medium | medium | Closer to | medium | <medium |
| Generation | | | | high | | |
| Duration/ | Medium | >medium | >medium | Closer to | >medium | medium |
| Term of PB | Term | | | high | | |
| Quantity of | High | >medium | >medium | >medium | >medium | <medium |
| PB | Capacity | | | | | |
| Customer | Residential | 0 | medium | Closer to | medium | <medium |
| Segments | | | | high | | |
| Current | In | >medium | 0 | >medium | <medium | <medium |
| Market price | Sync | | | | | |
| RPO | High | Closer to | >medium | 0 | >medium | >medium |
| Compliance | Penalty | high | | | | |
| Penalties | | | | | | |
| Frequent | First | medium | <medium | >medium | 0 | <medium |
| Purchaser | Time | | | | | |
| Forecasted | Low | <medium | <medium | >medium | <medium | 0 |
| Market Price | | | | | | |

| | | | Closer to | | | | |
|---|---|---|---|---|---|---|---|
| | Range | High | High | Medium | Medium | Medium | Low |
| Legands | Weightage | 20 | 16 to 19 | 11 to 15 | 10 | 5 to 9 | Less than 5 |

TABLE 3

| | | | | Demand/ | | Duration/ | |
|---|---|---|---|---|---|---|---|
| | | | | Load | Source | Term of | Quantity |
| | | | Landscape | High- | of | PB | of PB |
| | | Weather | Semi- | demand- | Generation | Medium | High |
| Variables | | Sunny | Urban | PB | Solar | Term | Capacity |
| Weather | Sunny | 0 | 8 | 10 | 7 | 8 | 8 |
| Landscape | Semi- | 8 | 0 | 8 | 7 | 8 | 7 |
| | Urban | | | | | | |
| Demand/ | High- | 10 | 8 | 0 | 8 | 8 | 8 |
| Load | demand- | | | | | | |
| | PB | | | | | | |
| Source of | Solar | 7 | 7 | 8 | 0 | 7 | 7 |
| Generation | | | | | | | |
| Duration/ | Medium | 8 | 8 | 8 | 7 | 7 | 7 |
| Term of | Term | | | | | | |
| PB | | | | | | | |
| Quantity | High | 8 | 7 | 8 | 7 | 0 | 0 |
| of PB | Capacity | | | | | | |
| Customer | Residential | 8 | 7 | 8 | 7 | 7 | 7 |
| Segments | | | | | | | |
| Current | In Sync | 7 | 7 | 7 | 7 | 7 | 7 |
| Market | | | | | | | |
| Price | | | | | | | |
| RPO | High | 7 | 8 | 10 | 8 | 7 | 7 |
| Compliance | Penalty | | | | | | |
| penalties | | | | | | | |
| Frequent | First | 7 | 7 | 7 | 5 | 7 | 7 |
| Purchaser | Time | | | | | | |
| Forecasted | Low | 7 | 5 | 7 | 3 | 3 | 3 |
| Market | | | | | | | |
| Price | | | | | | | |

| | | | | | | |
|---|---|---|---|---|---|---|
| Average | 7 | 7 | 7 | 6 | 6 | 6 |

| | | | Current | RPO | | | |
|---|---|---|---|---|---|---|---|
| | | | Market | Compliance | Frequent | Forecasted | |
| | | Customer | Price | Penalties | Purchaser | Market | |
| | | Segments | In | High | First | Price | |
| Variables | | Residential | Sync | Penalty | Time | Low | Average |
| Weather | Sunny | 8 | 7 | 7 | 7 | 7 | 7 |
| Landscape | Semi- | 7 | 7 | 8 | 7 | 5 | 7 |
| | Urban | | | | | | |
| Demand/ | High- | 8 | 7 | 10 | 7 | 7 | 7 |
| Load | demand- | | | | | | |
| | PB | | | | | | |
| Source of | Solar | 7 | 7 | 8 | 5 | 3 | 6 |
| Generation | | | | | | | |
| Duration/ | Medium | 7 | 7 | 8 | 7 | 5 | 7 |
| Term of | Term | | | | | | |
| PB | | | | | | | |
| Quantity | High | 7 | 7 | 7 | 7 | 3 | 6 |
| of PB | Capacity | | | | | | |
| Customer | Residential | 0 | 7 | 8 | 5 | 3 | 6 |
| Segments | | | | | | | |
| Current | In Sync | 7 | 0 | 7 | 3 | 3 | 6 |
| Market | | | | | | | |
| Price | | | | | | | |
| RPO | High | 8 | 7 | 0 | 7 | 7 | 7 |
| Compliance | Penalty | | | | | | |
| penalties | | | | | | | |
| Frequent | First | 5 | 3 | 7 | 0 | 3 | 5 |
| Purchaser | Time | | | | | | |
| Forecasted | Low | 3 | 3 | 7 | 3 | 0 | 4 |
| Market | | | | | | | |
| Price | | | | | | | |

| | | | | | |
|---|---|---|---|---|---|
| Average | 6 | 6 | 7 | 5 | 4 |

| | | | Closer | | | | | |
|---|---|---|---|---|---|---|---|---|
| | Range | High | to high | >Medium | Medium | <Medium | Low | Null |
| Legands | Weightage | 10 | 8 | 7 | 5 | 3 | 2 | 0 |

In an embodiment of the present invention, the virtual power bank generation unit 106 identifies the variables that correspond to the different types of dynamic actionable items and categorizes the dynamic actionable items based on the identified variables, as illustrated in table 4. The virtual power bank generation unit 106 then replaces the identified variables with the computed final weightage values corresponding to each of the variables. The virtual power bank generation unit 106 then carries out a third optimization operation by computing an average of the final weightage values for each of the variables associated with the dynamic actionable items for each row of the matrix. Finally, the virtual power bank generation unit 106 determines a maximum average value among all the computed average values associated with all the dynamic actionable items across each column of the matrix to determine a second weightage value, as illustrated in table 5. The second weightage value is the optimized final weightage value of the virtual power bank for which the end-consumer accessed the unified digital platform 106a. Likewise, optimized final weightage values are computed for multiple virtual power banks for end-consumers who access the unified digital platform 106a for obtaining virtual power banks.

TABLE 4

| Dynamic Actionable | | | | | |
|---|---|---|---|---|---|
| Item Types | Variables | | | | |
| Segmented Actionable | Landscape | Duration/ | Quantity | Consumer | Frequency |
| Item | | Term of PB | | Segments | |
| Time-based | Weather | Source of | Duration/ | Frequency | — |
| Actionable Item | | Generation | Term of PB | | |
| Peak Actionable Item | Demand/ | — | — | — | — |
| | Load | | | | |
| Penetration | Current | Forecasted | Duration/ | Frequency | |
| Actionable Item | Market Price | Market Price | Term of PB | | |
| Competitive | Current | Forecasted | — | — | — |
| Actionable Item | Market Price | Market Price | | | |
| Bulk Actionable Item | Duration/ | Quantity | — | — | — |
| | Term of PB | | | | |

TABLE 5

| Dynamic Actionable | | | | | | |
|---|---|---|---|---|---|---|
| Item Types | Variables | | | | | Average |
| Segmented Actionable | 7 | 7 | 6 | 6 | 5 | 6 |
| Item | | | | | | |
| Time-based Actionable | 7 | 6 | 7 | 5 | — | 6 |
| Item | | | | | | |
| Peak Actionable Item | 7 | — | — | — | — | 7 |
| Penetration Actionable | 6 | 4 | 7 | 5 | — | 6 |
| Item | | | | | | |
| Competitive Actionable | 6 | 4 | — | — | — | 5 |
| Item | | | | | | |
| Bulk Actionable Item | 7 | 6 | — | — | — | 7 |

| | |
|---|---|
| Second Final Weightage Value of PB | 7 |

In an embodiment of the present invention, the virtual power bank generation unit 106 determines the operational parameters for the virtual powers bank by carrying out a multiplication operation between the computed second weightage value and the threshold value, and then adjusting against the base value. The operational parameter is dynamic in nature, as it is based on dynamic actionable items that depend on the variables, which vary with respect to end-consumer requirements.

In an embodiment of the present invention, the visualization unit 108 is configured to render a Graphical User Interface (GUI) on the user device 116. The visualization unit 108 provides presentation and visualization of functionalities related to virtual power banks including, but not limited to, a dashboard, an application, and a portal for the end-consumers to access the unified digital platform 106a for operating or generating the virtual power banks. The application may be scalable depending on different functionalities provided by the visualization unit 108 including, but not limited to, utility administration related functions and end-consumer use cases. In an embodiment of the present invention, the visualization unit 108 provides a functionality for tracing the renewable energy source used to generate the power obtainable as virtual power banks. Further, the visualization unit 108 provides a functionality of determining the unused power associated with the end-consumer for re-using by listing the end-consumers having unused power. For example, if power is generated by using a roof top solar panel and the power is used to charge EV, then in order to feed excess power into the grid through net metering, the end-consumer may separately list the unused excess power to be fed to the grid on the cloud-based platform via the virtual power bank.

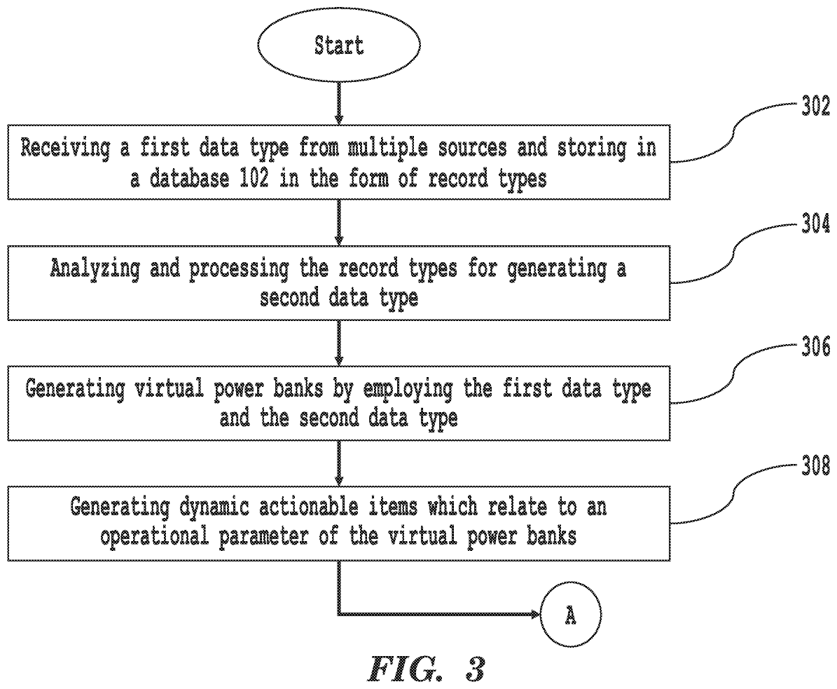

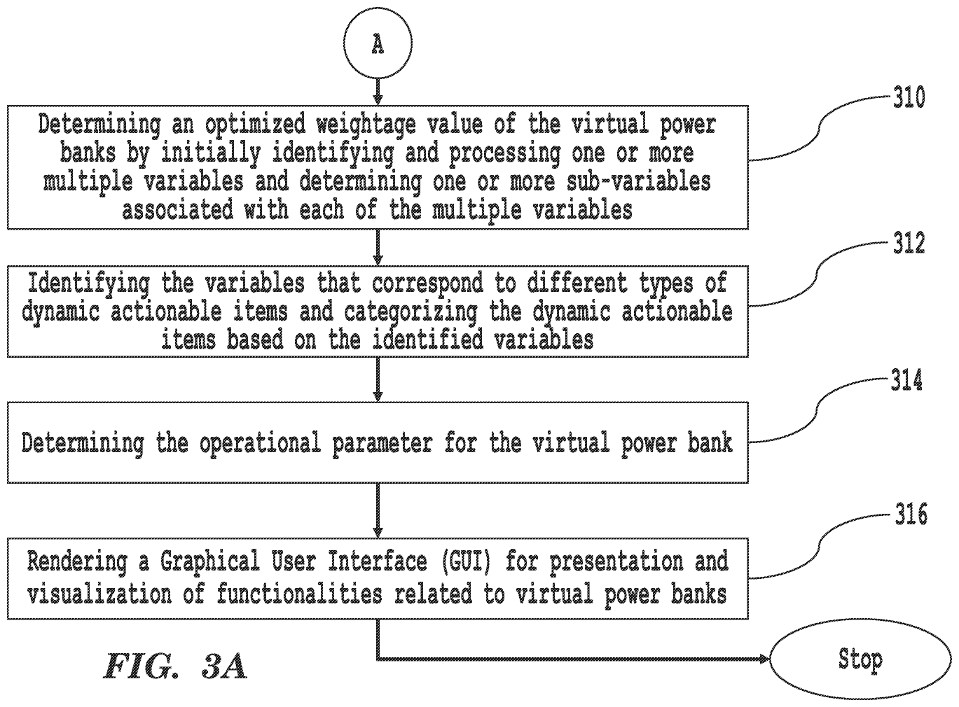

FIG. 3 and FIG. 3A is a flowchart illustrating a method for developing unified digital platform based virtual power banks for power management and settlement, in accordance with various embodiments of the present invention.

At step 302, the first data type is received from multiple sources and stored in a database 102 in the form of record types. In an embodiment of the present invention, the first data type represents data relating to power usage and requirements associated with multiple sources. The multiple sources include, but are not limited to, renewable energy generators, utility retailers, end-consumers, and Electric Vehicles (EV) charging stations. The first data type is stored in the database 102 in the form of different record types associated with each of the multiple sources. The one or more record types may include, but are not limited to, Power Purchase Agreement (PPA) records associated with the renewable energy generators, Renewable Purchase Obligation (RPO) records associated with the utility retailers, Power Bank (PB) contract records associated with end-consumers, billing and payment records associated with the EV charging stations. The first data type also includes data related to real-time power supply and demand received from one or more utilities and data related to multiple variables which are stored in the database 102. In an embodiment of the present invention, the record types are fetched from the database 102 for analysis and processing. At step 304, the record types are analyzed and processed for generating a second data type. In an embodiment of the present invention, one or more functionalities are utilized for analysis and processing of the record types to derive the second data type. The one or more functionalities include, but are not limited to, enterprise resource planning, Power Purchase Agreement (PPA) and Renewable Purchase Obligation (RPO) record management, Power Bank (PB) contract management, contract and transaction management, and end-consumer data management. The second data type is generated after analysis and processing of the record types and the second data type is stored in the database 102. In an exemplary embodiment of the present invention, the second data type includes data related to power usage. In an example, the second data type includes a quantum of power to be supplied i.e., capacity of the power banks, for instance power banks may be of a smaller capacity of 100 units or higher capacity of 1000 units. In another example, the second data type includes duration of supply per terms of usage of the power banks, for instance, some power banks may hold a shorter duration of 3 months or 6 months, while some other power banks may have a higher duration of 1 year, 2 years, etc. In yet another example, the second data type includes negotiated price of the power bank, for instance, higher the purchasing quantity of power banks by the end-consumer lesser could be the price, and in another instance, higher the duration lesser could be the price. In another example, the second data type includes penalties for non-compliance related to power supply and usage per the RPO. In yet another example, the second data type includes data related to end-consumer segments, for instance, category of consumers such as residential consumers buying for self-usage and commercial consumers buying for re-selling. In another example, the second data type includes sources of power generation, for instance, solar generators are available in markets at lower feed in tariff rates.

At step 306, virtual power banks are generated by employing the first data type and the second data type. In an embodiment of the present invention, virtual power banks are generated by employing the first data type and the second data type fetched from the database 102. The virtual power banks are small quantum of power entities hosted in the cloud-based unified digital platform. The virtual power banks are associated with one or more attributes including, but not limited to, different quantities of power (in kWh), time range for power utilization and price associated with the power based on the sources of renewable energy received from the renewable energy generators.

In an embodiment of the present invention, the virtual power banks utilize end-to-end encryption with blockchain technology containing smart contracts for its use by end-consumers, utility retailers and renewable energy generators. The smart contracts are digital logic agreements in a blockchain that contain terms which are automatically executed when pre-defined conditions related to power management and settlement through the virtual power banks are met. The smart contracts are generated based on the PPA record type of the second data type for the virtual power banks. In an exemplary embodiment of the present invention, the virtual power banks are operated based on four types of smart contracts. The first type of smart contract relates to PPA between the renewable energy generator and a utility retailer for trading renewable energy capacity. In an embodiment of the present invention, the first type of smart contract has a unique hash key function, which is generated between utility retailors and renewable energy generators and provides one or more predetermined conditions such as, but are not limited to, quantity, price, and timeline of generated power. The first type of smart contract (referred to as a parent smart contract) is bifurcated into multiple sub-contracts (which are associated with the virtual power banks) and are hosted in the cloud platform. Further, all the sub-contracts have a respective hash function, which is unique and random, thereby ensuring end-to-end encryption of the first type of smart contract. The hash function may be backtracked for generating the first type of contract. Further, the sub-contracts are purchased and sold multiple times and each sub-contract has a transaction appending buyer/seller token ID. A second type of smart contract relates to a PPA between the utility retailer and the end-consumer for trading with the power bank. A third type of smart contract relates to a PPA between the end-consumer and EV retailer for transfer of energy for charging of the EV vehicles. A fourth type of smart contract relates to a peer-to-peer contract between consumers with other end-consumers or with retailers in selling their unused power banks or the self-generated renewable energy power or power stored in the EV batteries.

At step 308, dynamic actionable items are generated which relate to an operational parameter of the virtual power banks. In an embodiment of the present invention, the dynamic actionable items are generated from the first data type that includes data related to real-time power supply and demand received from one or more utilities and data related to multiple variables, and the second data type fetched from the database 102. The data related to real-time power demand includes demand from both ends i.e., availability of power banks from utilities and availability of end-consumers to purchase the power banks. The multiple variables are dynamic in nature and are identified based on empirical studies.

In one example, the variables include season or weather i.e., availability of solar radiation is usually less in winter and high in summers. In another example, the variables include landscape conditions for instance, renewable energy sources and their availability has a high impact on landscape types, i.e., solar intensity is high in low-lying areas like urban, semi-urban, rural, semi-rural and remote areas, etc. In yet another example, the variables include the current market price i.e., the current renewable energy unit price in the market. In another example, the variables include frequent purchaser data. In yet another example, the variables include forecasted market price i.e., forecasted energy unit price of the market.

In an exemplary embodiment of the present invention, the dynamic actionable items include, but are not limited to, a segmented actionable item, a time-based actionable item, a peak actionable item, a penetration actionable item, a competitive actionable item, and a bulk actionable item. The segmented actionable item relates to the operational parameter of the virtual power bank based on geographical locations, frequency of usage, and duration of usage. The time-based actionable item relates to the operational parameter based on weather, and source of power generation. The peak actionable item relates to the operational parameter according to high demand times, and leverage data associated with the other power providers or generators, such as inventory or availability. The penetration actionable item relates to the operational parameter based on settling a lower value of power usage for effective management. The competitive actionable item relates to the operational parameter based on setting of a value of the power usage according to other power generators. The bulk actionable item relates to the operational parameter based on providing of a lower value to end-consumers for bulk usage.

In an embodiment of the present invention, the dynamic actionable items are generated by employing the first data type and the second data type based on a sequence of steps. Firstly, a base value, which is a power procurement value between the end-consumer and the renewable energy generator, is determined based on the PPA between the utility and the renewable energy generator. Secondly, a utility value associated with infrastructure usage allowance is determined based on which a threshold value is determined. The threshold value represents a minimum value below which the virtual power bank cannot be operated. Finally, an optimized weightage value of the virtual power banks is determined based on the first data type and the second data type.

At step 310, an optimized weightage value of the virtual power banks is determined by initially identifying and processing one or more multiple variables and determining one or more sub-variables associated with each of the multiple variables. In an embodiment of the present invention, for example, if the variable is weather and power is generated from solar energy, then the sub-variables may include, but are not limited to, sunny weather, cloudy weather, windy weather, rainy weather, snowy weather, and foggy weather, which may affect the power generation from the solar energy. In an embodiment of the present invention, the virtual power bank generation unit 106 computes an initial weightage value for each of the sub-variables. The virtual power bank generation unit 106 carries out a first optimization operation for optimizing the computed initial weightage values for each of the sub-variables. In an exemplary embodiment of the present invention, the first optimization operation is carried out by employing machine learning and deep learning techniques. During the first optimization operation, a model is trained iteratively that results in a maximum and minimum function evaluation. The results in every iteration are compared with each other by changing hyperparameters in each step until optimum results are obtained. Subsequently, an accurate model with less error rate is generated. In an exemplary embodiment of the present invention, the generated model is optimized by employing two optimization techniques including, but are not limited to, a gradient descent optimization technique and a stochastic gradient descent optimization technique. Based on the gradient descent optimization technique, variables' weights are updated iteratively in the opposite direction of one or more gradients of an objective function, which causes the model to find a target and converge the optimal value of the objective function based on each update of the weights. The convergence to the optimal value of the optimal function provides the optimal weights for the features. Based on the stochastic gradient descent technique, the gradients per iteration are updated using one sample randomly instead of directly computing the exact value of the gradient. Therefore, stochastic gradient descent technique provides an unbiased estimate of the real gradient. Advantageously, the stochastic gradient descent technique optimization method reduces update time for processing large numbers of samples and removes computational redundancy. Further, a proper learning rate of the model is determined for the stochastic gradient descent technique. The learning rate provides flexibility to the model by discarding certain segments of the data, however, the model may discard certain segments of data when the learning rate is high. Therefore, a low learning rate is carried out. The learning rate may be of different types including, but is not limited to, an adaptive gradient technique (Adagrad) that provides weights with a high gradient having low learning rate and vice versa, a Root Mean Squared Propagation (RMSprop) technique that adjusts the Adagrad method such that it reduces its monotonically decreasing learning rate, an Adam technique, which is similar to RMSProp but provides momentum, and an Alternating Direction Method of Multipliers (ADMM) technique that provides the stochastic gradient descent variants which is widely used in deep neural network techniques. Further, the gradient descent and AdaGrad technique varies with respect to each other based on the learning rate, which is not fixed and the learning rate is computed using all the historical gradients accumulated up to the latest iteration. The optimized initial weightage values computed for each of the sub-variables have been illustrated in table 1.

In an embodiment of the present invention, data associated with the sub-variables is captured for an end-consumer who accesses the unified digital platform for obtaining the virtual power bank. Based on the captured data, interdependency between each sub-variable with respect to another sub-variable is analyzed in a matrix form across rows and columns of the matrix, as illustrated in table 2. Based on the interdependency analysis, the initial weightage values of the interdepending sub-variables are added and subsequently a label is assigned (e.g., high, closer to high, medium, greater than medium, less than medium, low, etc.) to each of the sub-variables. The labels associated with each sub-variable are replaced with a numerical value. A second optimization operation carried out for optimizing the initial weightage values by computing an average of the numerical values assigned to each of the sub-variable in either of each row or column of the matrix to generate a first weightage value for each of the variables, as illustrated in Table 3.

At step 312, the variables that correspond to different types of dynamic actionable items are identified and the dynamic actionable items are categorized based on the identified variables, as illustrated in Table 4. In an embodiment of the present invention, the identified variables are replaced with the computed final weightage values corresponding to each of the variables. A third optimization operation is carried out by computing an average of the final weightage values for each of the variables associated with the dynamic actionable items for each row of the matrix. Finally, a maximum average value is determined among all the computed average values associated with all the dynamic actionable items across each column of the matrix to determine a second weightage value, as illustrated in table 5. The second weightage value is the optimized final weightage value of the virtual power bank for which the end-consumer accessed the unified digital platform. Likewise, optimized final weightage values are computed for multiple virtual power banks for end-consumers who access the unified digital platform 106a for obtaining virtual power banks.

At step 314, the operational parameter for the virtual power bank is determined. In an embodiment of the present invention, the operational parameter for the virtual power bank is determined by carrying out a multiplication operation between the computed second weightage value and the threshold value, and then adjusting against the base value. The operational parameter is dynamic in nature, as it is based on dynamic actionable items that depend on the variables, which vary with respect to end-consumer requirements.

At step 316, a Graphical User Interface (GUI) is rendered for presentation and visualization of functionalities related to virtual power banks. In an embodiment of the present invention, presentation and visualization of functionalities related to virtual power banks are provided including, but not limited to, a dashboard, an application, and a portal for the end-consumers to access the unified digital platform 106a for operating or generating the virtual power banks. The application may be scalable depending on different functionalities including, but not limited to, utility administration related functions and end-consumer use cases. In an embodiment of the present invention, a functionality is provided for tracing the renewable energy source used to generate the power obtainable as virtual power banks. Further, a functionality of determining the unused power associated with the end-consumer is provided for re-using by listing the end-consumers having unused power. For example, if power is generated by using a roof top solar panel and the power is used to charge EV, then in order to feed excess power into the grid through net metering, the end-consumer may separately list the unused excess power to be fed to the grid on the cloud-based platform via the virtual power bank.

Advantageously, in accordance with various embodiments of the present invention, the present invention provides for access to end-consumers to power generated from renewable energy sources via a cloud-based unified digital platform. The present invention provides for efficient power management and settlement via the unified digital platform. Also, the present invention provides for utilization and re-utilization of power generated from renewable energy sources. Further, the present invention provides for tracking and locating the type of source of power at a granular level. Yet further, the present invention provides for improved load forecasting by the power generator associated with the renewable energy source power ensuring grid stability. Furthermore, the present invention provides for enhanced transparency in the utilization of power generated using renewable energy sources by end-consumers for accelerating renewable energy usage. Yet further, the present invention provides for effective charging of EVs.

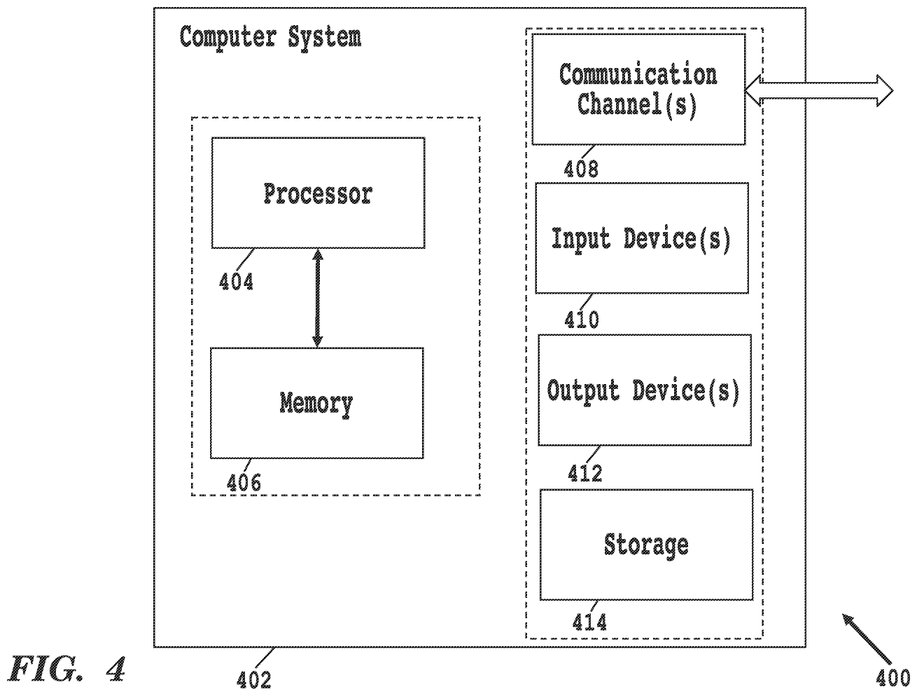

FIG. 4 illustrates an exemplary computer system in which various embodiments of the present invention may be implemented. The computer system 402 comprises a processor 404 and a memory 406. The processor 404 executes program instructions and is a real processor. The computer system 402 is not intended to suggest any limitation as to scope of use or functionality of described embodiments. For example, the computer system 402 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In various embodiments of the present invention, operating system software (not shown) provides an operating environment for various softwares executing in the computer system 402 and manages different functionalities of the components of the computer system 402.

The communication channel(s) 408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth, or other transmission media.

The input device(s) 410 may include, but not limited to, a keyboard, mouse, pen, joystick, trackball, a voice device, a scanning device, touch screen or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but not limited to, magnetic disks, magnetic tapes, CD-ROMs, CD-RWs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including, but not limited to, microwave, infrared, Bluetooth, or other transmission techniques. These instructions can be preloaded into a system or recorded on a storage medium such as a CD-ROM or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for developing unified digital platform based virtual power banks, the system comprises:
a memory storing program instructions; and
a processor executing program instructions stored in the memory and configured to:
derive a second data type by analyzing one or more record types, wherein the record types are obtained from a first data type received from multiple sources and stored in a database;
generate virtual power banks by employing the first data type and the second data type fetched from the database, wherein the virtual power banks are associated with one or more attributes relating to power management and settlement;
generate one or more dynamic actionable items relating to the virtual power banks from the first data type and the second data type;
identify one or more variables that correspond to different types of the dynamic actionable items for categorizing the dynamic actionable items based on the identified variables; and
perform optimization operations on values of each of the identified variables to obtain an optimized final weightage value of the virtual power banks, accessed via a unified digital platform, based on which one or more operational parameters associated with the virtual power banks are determined.

2. The system as claimed in claim 1, wherein the first data type represents data relating to power usage, requirements associated with multiple sources, data related to real-time power supply and demand received from one or more utilities and data related to multiple variables which are stored in the database, the multiple sources comprise renewable energy generators, utility retailers, end-consumers, and Electric Vehicle (EV) charging stations.

3. The system as claimed in claim 1, wherein the one or more record types comprise Power Purchase Agreement (PPA) records associated with the renewable energy generators, Renewable Purchase Obligation (RPO) records associated with utility retailers, Power Bank (PB) contract records associated with end-consumers, and billing and payment records associated with EV charging stations.

4. The system as claimed in claim 1, wherein the system comprises a data analytics unit executed by the processor and configured to derive the second data type based on one or more functionalities comprising enterprise resource planning, PPA and RPO record management, PB contract management, contract and transaction management, and end-consumer data management.

5. The system as claimed in claim 1, wherein the second data type comprises data related to power usage, a quantum of power to be supplied, duration of supply per terms of usage of the virtual power banks, negotiated price of the virtual power banks, penalties for non-compliance related to power supply and usage per RPO, data related to end-consumer segments, and sources of power generation.

6. The system as claimed in claim 1, wherein the attributes associated with the virtual power banks comprise different quantities of power (in kWh), time range for power utilization and price associated with the power based on the sources of renewable energy received from the renewable energy generators.

7. The system as claimed in claim 1, wherein the virtual power banks employ end-to-end encryption with blockchain technology containing smart contracts for use by end-consumers, utility retailers and renewable energy generators.

8. The system as claimed in claim 7, wherein the virtual power banks are operated based on four types of smart contracts including a first type of smart contract relating to a PPA between the renewable energy generator and the utility retailer for trading renewable energy capacity, a second type of smart contract relating to a PPA between the utility retailer and the end-consumer for trading the virtual power banks, a third type of smart contract relating to a PPA between the end-consumer and an EV retailer for transfer of energy for charging of EV vehicles, and a fourth type of smart contract relating to a peer-to-peer contract between the end-consumer with other end-consumers or with retailers in selling their unused virtual power banks or self-generated renewable energy power or power stored in batteries of the EV vehicles.

9. The system as claimed in claim 8, wherein the first type of smart contract has a unique hash key function, which is generated between the utility retailors and the renewable energy generators and provides one or more predetermined conditions comprising, quantity, price, and timeline of generated power.

10. The system as claimed in claim 9, wherein the first type of smart contract is bifurcated into multiple sub-contracts which are associated with the virtual power banks and are hosted in a cloud platform, and wherein the sub-contracts have unique hash functions that ensure end-to-end encryption of the first type of contract, and wherein the hash function is backtracked for generating the first type of smart contract, each sub-contract has a transaction appending a buyer or a seller token ID.

11. The system as claimed in claim 1, wherein the dynamic actionable items that are generated from the first data type includes data related to real-time power supply and demand received from one or more utilities and data related to multiple variables, and the second data type fetched from the database.

12. The system as claimed in claim 1, wherein the dynamic actionable items comprise a segmented actionable item, a time-based actionable item, a peak actionable item, a penetration actionable item, a competitive actionable item, and a bulk actionable item, and wherein the multiple variables include season or weather, landscape conditions, current market price, frequent purchaser data, forecasted market price.

13. The system as claimed in claim 1, wherein the system comprises a virtual power bank generation unit executed by the processor and configured to generate the dynamic actionable items by employing the first data type and the second data type based on a sequence of steps comprising:
determining a base value relating to a power procurement value between an end-consumer and a renewable energy generator based on a PPA between a utility and a renewable energy generator;
determining a utility value associated with infrastructure usage allowance based on which a threshold value is determined, wherein the threshold value represents a minimum value below which the virtual power banks cannot be operated; and
determining an optimized weightage value of the virtual power banks based on the first data type and the second data type by initially identifying and processing the one or more multiple variables and to determine one or more sub-variables associated with each of the multiple variables.

14. The system as claimed in claim 13, wherein the virtual power bank generation unit computes an initial weightage value for each of the sub-variables, and carries out a first optimization operation for optimizing the computed initial weightage values for each of the sub-variables, and wherein the first optimization operation is carried out by employing machine learning and deep learning techniques to train a model iteratively that results in a maximum and minimum function evaluation.

15. The system as claimed in claim 13, wherein the virtual power bank generation unit captures data associated with the sub-variables for the end-consumer who accesses the unified digital platform for obtaining the virtual power banks, and wherein the virtual power bank generation unit analyzes interdependency between each sub-variable with respect to another sub-variable based on the captured data in a matrix form across rows and columns of the matrix.

16. The system as claimed in claim 14, wherein the virtual power bank generation unit adds the initial weightage values of the interdepending sub-variables based on the interdependency analysis and subsequently assigns a label to each of the sub-variables, and wherein the labels associated with each sub-variable are replaced with a numerical value.

17. The system as claimed in claim 16, wherein the virtual power bank generation unit carries out a second optimization operation for optimizing the initial weightage values by computing an average of the numerical values assigned to each of the sub-variable in either of each row or column of the matrix to generate a first weightage value for each of the variables.

18. The system as claimed in claim 17, wherein the virtual power bank generation unit replaces the identified variables with one or more computed final weightage values corresponding to each of the variables, and wherein the virtual power bank generation unit carries out a third optimization operation by computing an average of the final weightage values for each of the variables associated with the dynamic actionable items for each row of a matrix.

19. The system as claimed in claim 18, wherein the virtual power bank generation unit determines a maximum average value from the computed final weightage average values associated with all the dynamic actionable items across each column of the matrix to determine a second weightage value, and wherein the second weightage value is the optimized final weightage value of the virtual power banks.

20. The system as claimed in claim 19, wherein the virtual power bank generation unit determines the operational parameters for the virtual power banks by carrying out a multiplication operation between the computed second weightage value and the threshold value, and then adjusting against the base value.

21. The system as claimed in claim 1, wherein the system comprises a visualization unit executed by the processor and configured to render a Graphical User Interface (GUI) on a user device for providing visualization functionalities comprising a dashboard, an application, and a portal for end-consumers to access the unified digital platform for operating or generating the virtual power banks.

22. The system as claimed in claim 21, wherein the visualization unit provides a functionality for tracing the renewable energy source used to generate the power obtainable as virtual power banks, and wherein the visualization unit provides a functionality of determining the unused power associated with the end-consumer for re-using by listing the end-consumers having unused power.

23. A method for developing unified digital platform based virtual power banks, the method is implemented by a processor configured to execute instructions stored in a memory, the method comprises:
deriving a second data type by analyzing one or more record types, wherein the record types are obtained from a first data type received from multiple sources and stored in a database;
generating virtual power banks by employing the first data type and the second data type fetched from the database, wherein the virtual power banks are associated with one or more attributes relating to power bank management and settlement;
generating one or more dynamic actionable items relating to the virtual power banks from the first data type and the second data type;
identifying one or more variables that correspond to different types of the dynamic actionable items for categorizing the dynamic actionable items based on the identified variables; and
performing optimization operations on values of each of the identified variables associated with the dynamic actionable items to obtain an optimized final weightage value of the virtual power banks, accessed via a unified digital platform, based on which one or more operational parameters associated with the virtual power banks are determined.

24. The method as claimed in claim 23, wherein the record types are analyzed to derive the second data type based on one or more functionalities comprising enterprise resource planning, Power Purchase Agreement (PPA) and Renewable Purchase Obligation (RPO) record management, Power Bank (PB) contract management, contract and transaction management, and end-consumer data management.

25. The method as claimed in claim 23, wherein the virtual power banks are operated based on four types of smart contracts, and wherein a first type of smart contract relates to PPA between a renewable energy generator and a utility retailer for trading renewable energy capacity, a second type of smart contract relates to a PPA between the utility retailer and an end-consumer for trading the virtual power banks, a third type of smart contract relates to a PPA between the end-consumer and an EV retailer for transfer of energy for charging of EV vehicles, and a fourth type of smart contract relates to a peer-to-peer contract between consumers with other end-consumers or with retailers in selling their unused power banks or self-generated renewable energy power or power stored in batteries of the EV vehicles.

26. The method as claimed in claim 25, wherein the first type of smart contract has a unique hash key function, which is generated between the utility retailors and the renewable energy generators and provides one or more predetermined conditions comprising, quantity, price, and timeline of generated power.

27. The method as claimed in claim 26, wherein the first type of smart contract is bifurcated into multiple sub-contracts which are associated with the virtual power banks and are hosted in a cloud platform, and wherein the sub-contracts have unique hash functions that ensure end-to-end encryption of the first type of contract, and wherein the hash function is backtracked for generating the first type of smart contract, each sub-contract has a transaction appending a buyer or a seller token ID.

28. The method as claimed in claim 23, wherein the dynamic actionable items are generated from the first data type that includes data related to real-time power supply and demand received from one or more utilities and data related to multiple variables, and the second data type.

29. The method as claimed in claim 28, wherein the dynamic actionable items comprise a segmented actionable item, a time-based actionable item, a peak actionable item, a penetration actionable item, a competitive actionable item, and a bulk actionable item, and wherein the multiple variables include season or weather, landscape conditions, current market price, frequent purchaser data, forecasted market price.

30. The method as claimed in claim 23, wherein the dynamic actionable items are generated by employing the first data type and the second data type based on a sequence of steps comprising:
determining a base value relating to a power procurement value between an end-consumer and a renewable energy generator based on a PPA between a utility and a renewable energy generator;
determining a utility value associated with infrastructure usage allowance based on which a threshold value is determined, wherein the threshold value represents a minimum value below which the virtual power banks cannot be operated; and
determining an optimized weightage value of the virtual power banks based on the first data type and the second data by initially identifying and processing the one or more variables to determine one or more sub-variables associated with each of the multiple variables.

31. The method as claimed in claim 30, wherein the step of performing optimization operations comprises computing an initial weightage value for each of the sub-variables, and carrying out a first optimization operation for optimizing the computed initial weightage values for each of the sub-variables by employing machine learning and deep learning techniques to train a model iteratively that results in a maximum and minimum function evaluation.

32. The method as claimed in claim 31, wherein data associated with the sub-variables is captured for the end-consumer who accesses the unified digital platform for obtaining the virtual power banks, and wherein interdependency between each sub-variable is analyzed with respect to another sub-variable based on the captured data in a matrix form across rows and columns of the matrix.

33. The method as claimed in claim 31, wherein the initial weightage values of the interdepending sub-variables are added based on the interdependency analysis and subsequently a label is assigned to each of the sub-variables, and wherein the labels associated with each sub-variable are replaced with a numerical value.

34. The method as claimed in claim 33, wherein the step of performing optimization operations comprises carrying out a second optimization operation for optimizing the initial weightage values by computing an average of the numerical values assigned to each of the sub-variable in either of each row or column of the matrix to generate a first weightage value for each of the variables.

35. The method as claimed in claim 34, wherein the step of performing optimization operation comprises replacing the identified variables with one or more computed final weightage values corresponding to each of the variables, and carrying out a third optimization operation by computing an average of the final weightage values for each of the variables associated with the dynamic actionable items for each row of a matrix.

36. The method as claimed in claim 35, wherein the step of performing optimization comprises determining a maximum average value from the computed final weightage average values associated with all the dynamic actionable items across each column of the matrix to determine a second weightage value, and wherein the second weightage value is the optimized final weightage value of the virtual power banks.

37. The method as claimed in claim 36, wherein the operational parameters for the virtual power banks are determined by carrying out a multiplication operation between the computed second weightage value and the threshold value, and then adjusting against the base value.

38. A computer program product comprises:
a non-transitory computer-readable medium having computer program code stored thereon, the computer-readable program code comprising instructions that, when executed by a processor, causes the processor to:
derive a second data type by analyzing one or more record types, wherein the record types are obtained from a first data type received from multiple sources and stored in a database;
generate virtual power banks by employing the first data type and the second data type fetched from the database, wherein the virtual power banks are associated with one or more attributes relating to power management and settlement;
generate one or more dynamic actionable items relating to the virtual power banks from the first data type and the second data type.
identify one or more variables that correspond to different types of the dynamic actionable items for categorizing the dynamic actionable items based on the identified variables; and
perform optimization operations on values of each of the identified variables to obtain an optimized final weightage value of the virtual power banks, accessed via a unified digital platform, based on which one or more operational parameters associated with the virtual power banks are determined.
